(19) United States
(12) Patent Application Publication
(10) Pub. No.: US 2011/0243099 A1
(43) Pub. Date: Oct. 6, 2011

(54) Method of Service Redirection Procedures in TD-SCDMA and GSM Hybrid Mobile Terminals

(76) Inventors: Tom Chin, San Diego, CA (US); Guangming Shi, San Diego, CA (US); Kuo-Chun Lee, San Diego, CA (US)

(21) Appl. No.: 12/850,378

(22) Filed: Aug. 4, 2010

Related U.S. Application Data
(60) Provisional application No. 61/319,545, filed on Mar. 31, 2010.

(51) Int. Cl. H04B 7/216; H04B 7/00

(52) U.S. Cl. 370/335; 370/310; 370/342

(57) ABSTRACT

Certain aspects of the present disclosure propose techniques for service redirection in Time Division Synchronous Code Division Multiple Access (TD-SCDMA) and Global System for Mobile communications (GSM) hybrid mobile terminals.

### CLAIM OF PRIORITY UNDER 35 U.S.C. §119

This application claims the benefit of U.S. Provisional Patent Application No. 61/319,545 entitled: “Method of Service Redirection Procedures in TD-SCDMA and GSM Hybrid Mobile Terminals,” filed on Mar. 31, 2010, the disclosure of which is expressly incorporated by reference herein in its entirety.

### BACKGROUND

1. Field

Aspects of the present disclosure relate generally to wireless communications, and more particularly, to a method of service redirection procedures in hybrid mobile terminals supporting technologies based on Time Division Synchronous Code Division Multiple Access (TD-SCDMA) and Global System for Mobile communications (GSM).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UTMS), a third generation (3G) mobile phone technology supported by the 3rd Generation Partnership Project (3GPP). The UMTS, which is the successor to Global System for Mobile communications (GSM) technologies, currently supports various air interface standards, such as Wideband-Code Division Multiple Access (W-CDMA), Time Division-Code Division Multiple Access (TD-CDMA) and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but also to advance and enhance the user experience with mobile communications.

### SUMMARY

Certain aspects of the present disclosure provide a method of wireless communication by a multi-mode user equipment (UE). The method generally includes selecting a first radio access technology (RAT) to conduct a Packet-Switched (PS) call, when both the first RAT and a second RAT are available, and selecting the second RAT to conduct a Circuit-Switched (CS) call, when both the first RAT and the second RAT are available.

Certain aspects of the present disclosure provide an apparatus for wireless communication. The apparatus generally includes means for selecting a first radio access technology (RAT) to conduct a Packet-Switched (PS) call, when both the first RAT and a second RAT are available, and means for selecting the second RAT to conduct a Circuit-Switched (CS) call, when both the RAT and the second RAT are available.

Certain aspects of the present disclosure provide a computer program product. The computer program product generally includes a computer-readable medium comprising code for selecting a first radio access technology (RAT) to conduct a Packet-Switched (PS) call, when both the first RAT and a second RAT are available, and selecting the second RAT to conduct a Circuit-Switched (CS) call, when both the RAT and the second RAT are available.

Certain aspects of the present disclosure provide an apparatus for wireless communication. The apparatus generally includes at least one processor, and a memory coupled to the at least one processor, wherein the at least one processor is configured to select a first radio access technology (RAT) to conduct a Packet-Switched (PS) call, when both the first RAT and a second RAT are available, and select the second RAT to conduct a Circuit-Switched (CS) call, when both the RAT and the second RAT are available.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a user equipment (UE) in a telecommunications system.

FIG. 4 illustrates an example topology of Time Division Synchronous Code Division Multiple Access (TD-SCDMA) coverage and Global System for Mobile communications (GSM) coverage in accordance with certain aspects of the present disclosure.

FIG. 5 is a block diagram conceptually illustrating an example of hardware configuration of a hybrid mobile terminal in accordance with certain aspects of the present disclosure.

FIG. 6 illustrates an example message sequence for a handover from a TD-SCDMA network to a GSM network in accordance with certain aspects of the present disclosure.

FIG. 7 is a functional block diagram conceptually illustrating example blocks executed at a UE to implement the functional characteristics of one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

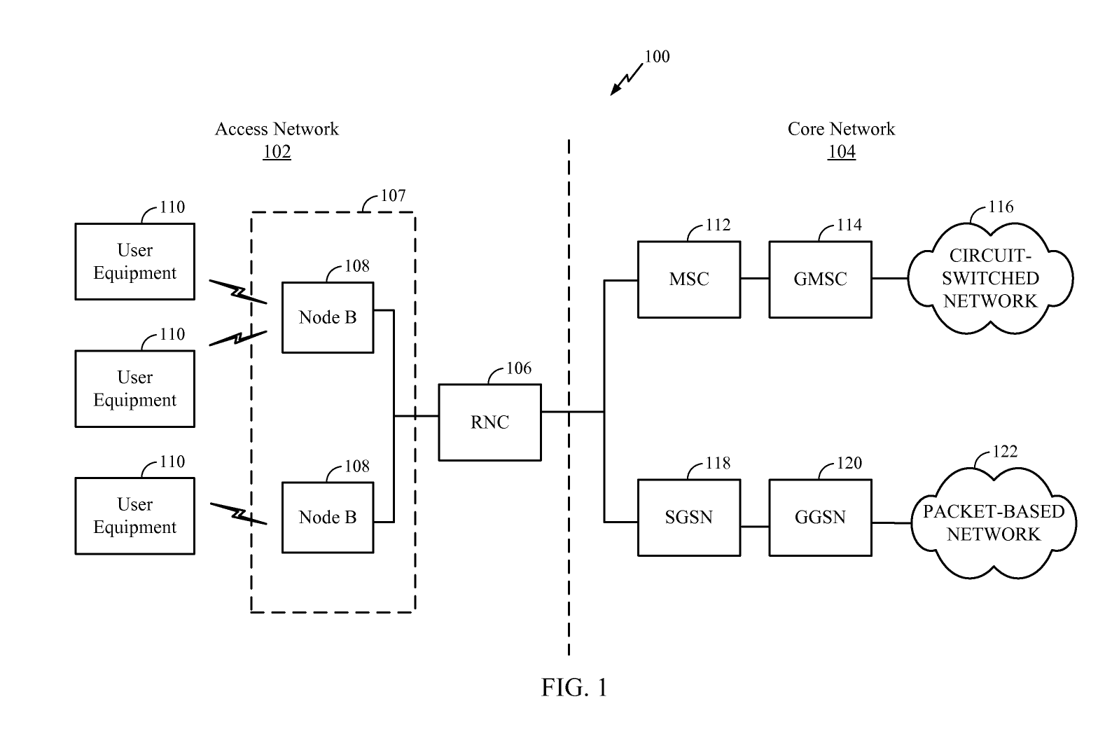

Turning now to FIG. 1, a block diagram is shown illustrating an example of a telecommunications system 100. The various concepts presented throughout this disclosure may be implemented across a broad variety of telecommunication systems, network architectures and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

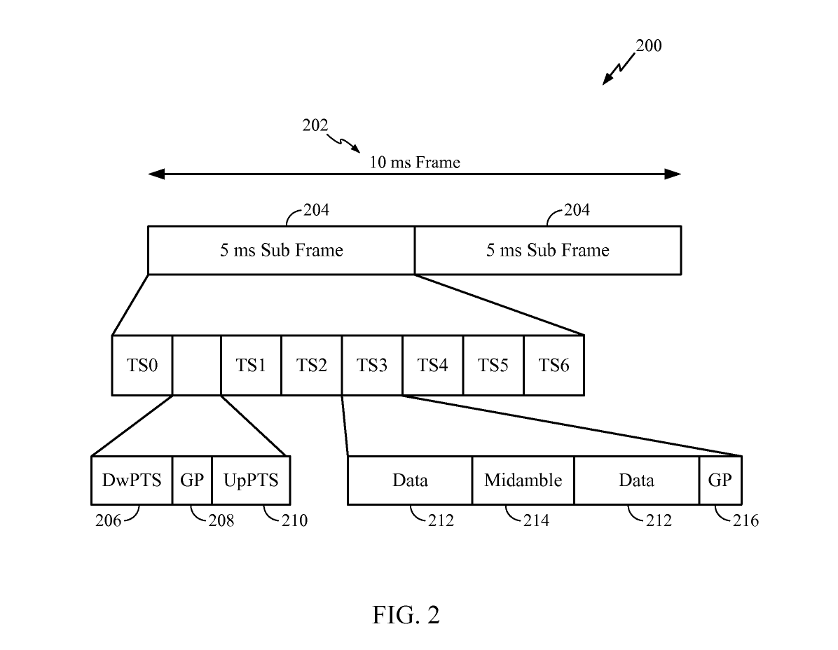

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

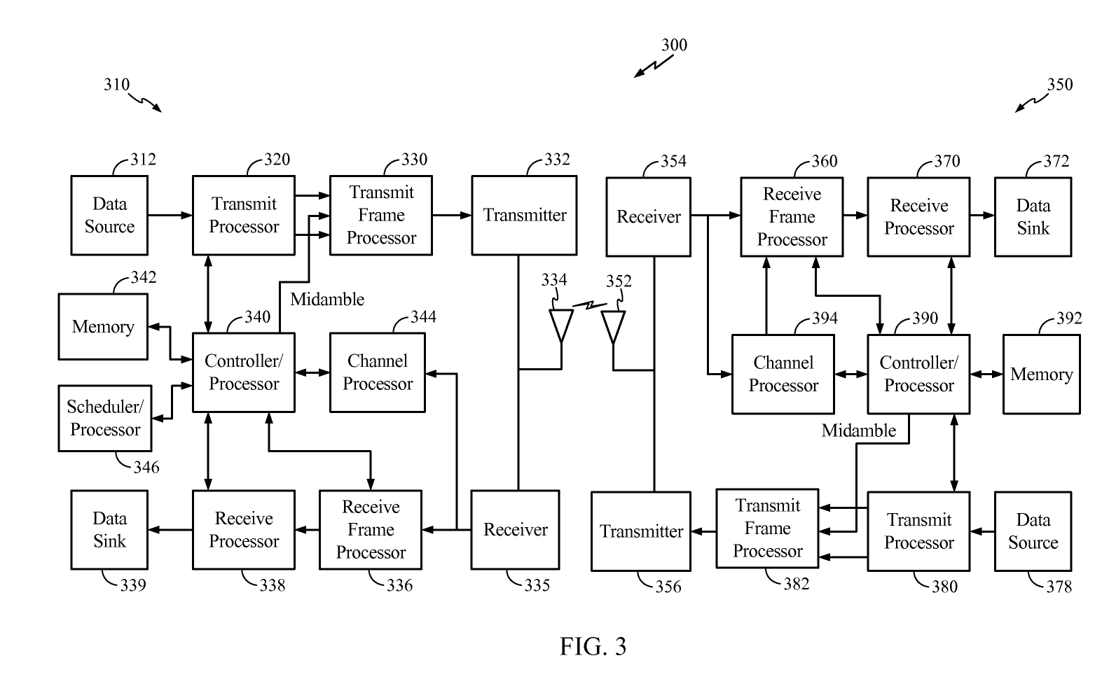

FIG. 3 is a block diagram of a Node B 310 in communication with a UE 350 in a RAN 300, where the RAN 300 may be the RAN 102 in FIG. 1, the Node B 310 may be the Node B 108 in FIG. 1 and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

Service Redirection Procedures in Hybrid Mobile Terminals

In the migration from GSM radio access technology (RAT) to TD-SCDMA RAT, a UE (e.g., the UE 350 illustrated in FIG. 3) may have radio coverage in several different cases. In one case, both radio coverage of GSM and TD-SCDMA networks may be available. In another case, only the GSM coverage may be available, but there may be no TD-SCDMA network coverage available. In yet another case, only the TD-SCDMA coverage may be available, but there may be no GSM coverage available.

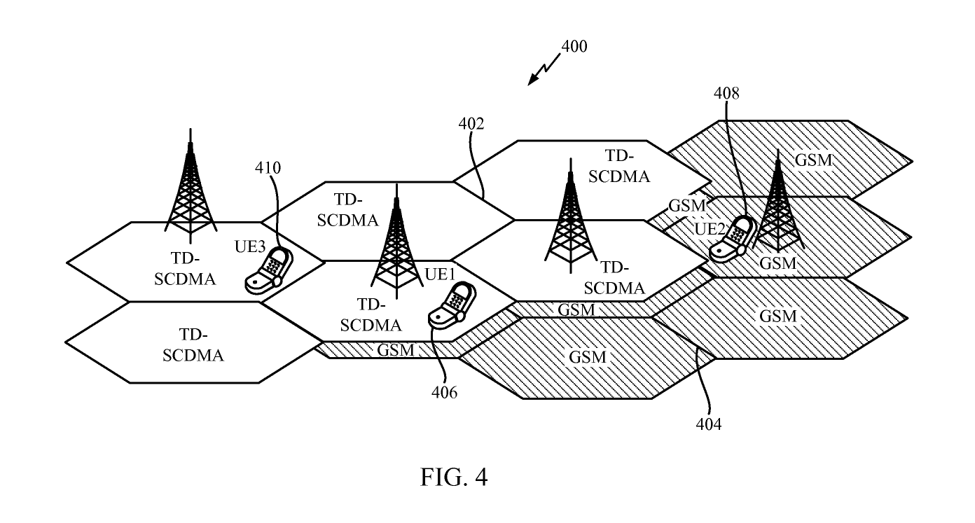

FIG. 4 illustrates an example topology 400 of TD-SCDMA network coverage 402 and GSM network coverage 404 in accordance with certain aspects of the present disclosure. For example, a UE 406 may experience both the GSM coverage 404 and the TD-SCDMA coverage 402, a UE 408 may be only within the GSM coverage 404, while a UE 410 may be only within the TD-SCDMA coverage 402.

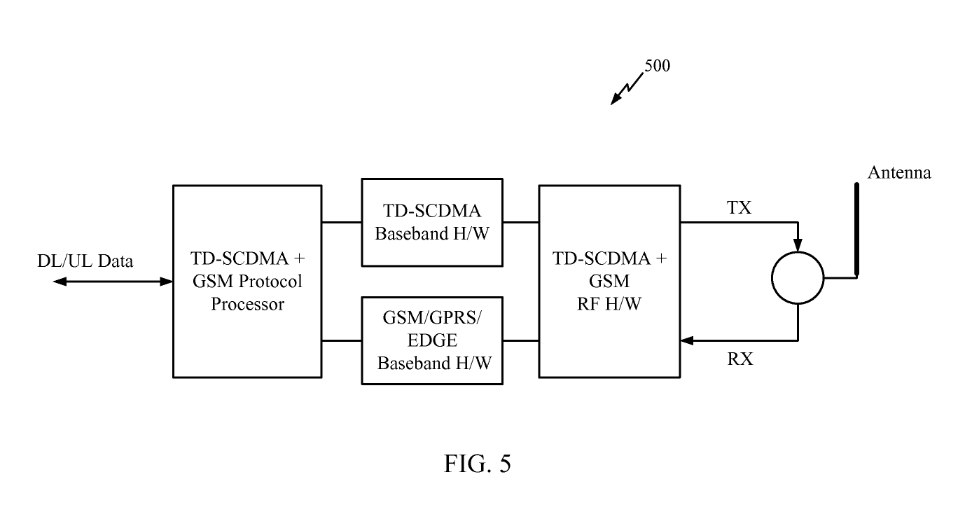

A mobile terminal may comprise hardware and protocol stacks of both GSM and TD-SCDMA RATs. One UE hardware configuration may comprise a hybrid configuration in which the UE may only comprise one Radio Frequency (RF) chain. Therefore, the UE may be active transmitting or receiving through either TD-SCDMA or GSM but not using both RATs at any time. FIG. 5 is a block diagram 500 conceptually illustrating an example of hardware configuration of such a hybrid mobile terminal in accordance with certain aspects of the present disclosure.

The hybrid hardware 500 may choose to connect to one particular RAT for communication in the connected mode or to monitor one particular RAT in the idle mode at any time instance. However, from the service perspectives, a Circuit-Switched (CS) voice call may be preferred to be conducted using the GSM RAT, while a Packet-Switched (PS) data call may be preferred to be conducted using the TD-SCDMA RAT. This is because the RAT operating according to TD-SCDMA may provide a higher data rate, while the RAT operating according to GSM may be more matured for the CS service in handover and may provide more network coverage than the TD-SCDMA RAT.

It should be noted that the GSM network in the present disclosure may also refer to General Packet Radio Service (GPRS) PS data service. Therefore, either the GSM or the TD-SCDMA may still provide both CS voice and PS data service although the GSM may offer better CS voice service and the TD-SCDMA may offer better PS data service.

Certain aspects of the present disclosure support a procedure that allows a UE to monitor only one RAT and set up a call in a preferred RAT. The present disclosure proposes that the UE may stay with a specific RAT according to details given below.

If only the TD-SCDMA network coverage is available, then the UE may be conducting both CS and PS calls using the TD-SCDMA RAT. If only the GSM network coverage is available, then the UE may be allowed to conduct both the CS and PS calls using the GSM RAT.

In case when both the GSM coverage and the TD-SCDMA coverage are available, as illustrated in FIG. 4 for the UE 406, then the UE may monitor the TD-SCDMA network in its idle mode. In case of Mobile Originated (MO) or Mobile Terminated (MT) PS call, this particular PS call may be originated using the TD-SCDMA RAT. In case of MO CS call, a cell reselection to the GSM network may be first performed before originating this CS call using the GSM RAT. In case of MT CS call, the UE may originate this call in the TD-SCDMA network, and then a handover to the GSM network may be performed.

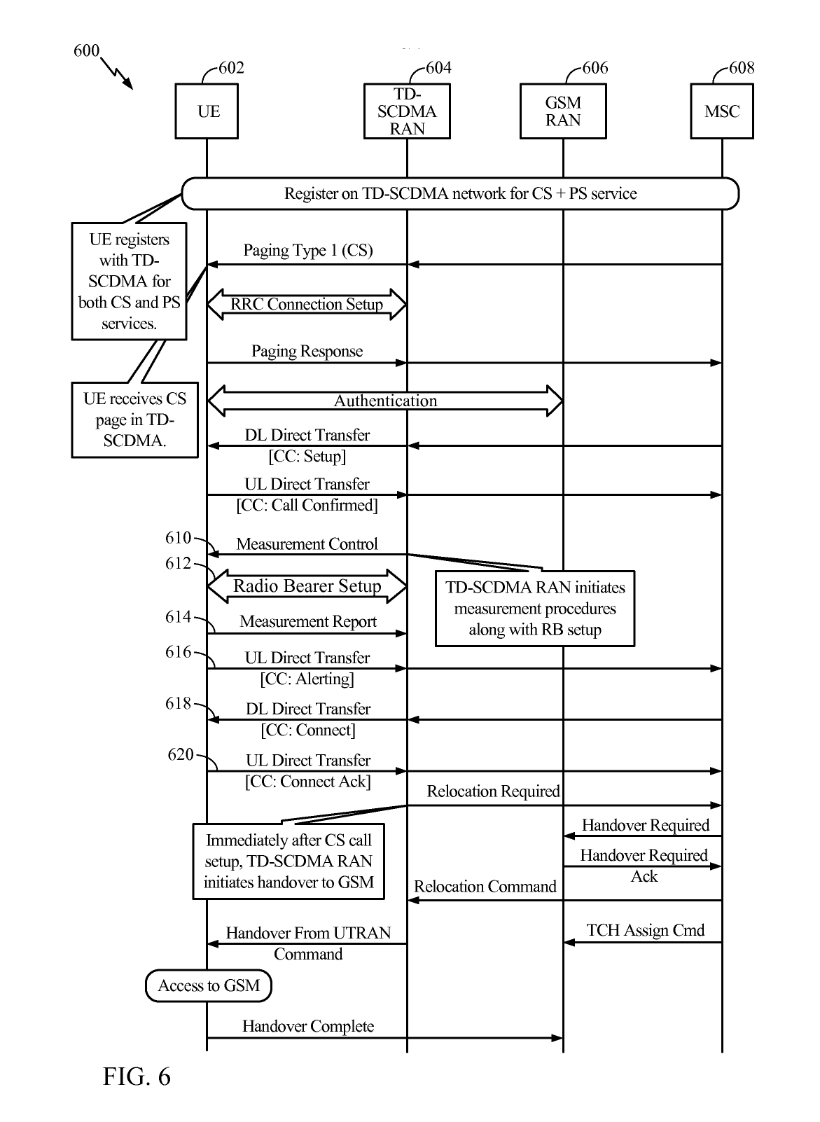

FIG. 6 illustrates an example message sequence 600 for a handover of a UE 602, wherein the handover may be conducted from a TD-SCDMA Radio Access Network (RAN) 604 to a GSM RAN 606 in accordance with certain aspects of the present disclosure. As illustrated in FIG. 6, the UE 602 may register with the TD-SCDMA RAN 604 for both CS and PS services. Therefore, the UE 602 may receive a CS page from the TD-SCDMA RAN 604.

The present disclosure proposes to set up, for example, a MT CS call in the TD-SCDMA RAN 604, and then immediately relocating this call to the GSM RAN 606. Immediately after setting up the MT CS call in the TD-SCDMA RAN 604, the TD-SCDMA RAN may perform handover from the TD-SCDMA RAN to the GSM RAN.

In order for the TD-SCDMA RAN 604 to determine a target GSM cell for the handover, the TD-SCDMA RAN 604 may transmit to the UE 602 a Measurement Control message 610 and a Radio Bearer (RB) Setup message 612 initiating measurement procedures along with the RB setup. In response to the messages 610 and 612, the UE 602 may transmit, to the TD-SCDMA RAN 604, a measurement report 614 related to a GSM neighbor cell (i.e., a target cell).

In order for the TD-SCDMA RAN 604 to trigger the handover, a timer starting from the Radio Bearer Setup message 612 may need to be elapsed. The UE 602 may first set up the CS call, as illustrated in FIG. 6. The UE 602 may transmit a Call Control (CC) message 616 to the TD-SCDMA RAN 604, which may be forwarded to a mobile switching center (MSC) 608. After the MSC 608 detects that the UE 602 transmitted the CC message 616, a CC connect message 618 may be transmitted from the MSC 608 to the TD-SCDMA RAN 604 and then forwarded to the UE 602 from the TD-SCDMA RAN 604. Following this, a connect acknowledgement message 620 originated from the UE 602 may be transmitted to the MSC 608 in order to acknowledge the CS call setup in the TD-SCMDA RAN 604. Immediately after the CS call is being set up in the TD-SCDMA RAN 604, the TD-SCDMA RAN 604 may initiate a relocation procedure (handover) for the CS call to the target GSM cell of the GSM RAN 606, as illustrated in FIG. 6.

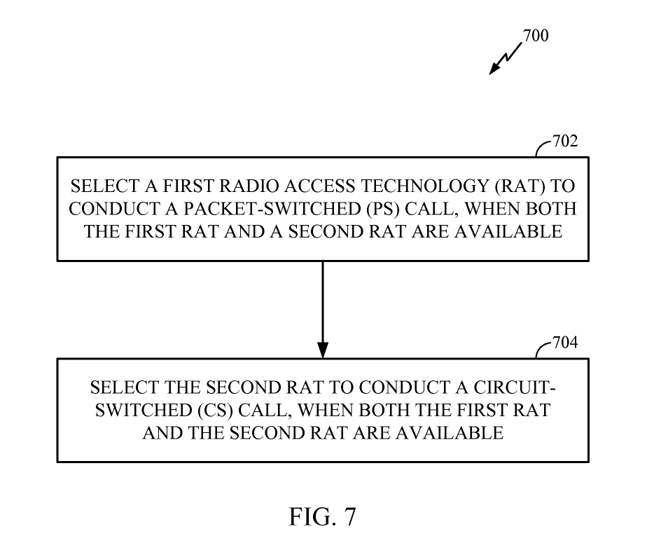

FIG. 7 is a functional block diagram conceptually illustrating example blocks executed at a UE to implement the functional characteristics of one aspect of the present disclosure. Operations illustrated by the blocks 700 may be executed, for example, by the processors 370 and 380 of the UE 350 from FIG. 3. In block 702, the UE may select a first RAT to conduct a PS call, when both the first RAT and a second RAT are available. In addition, in block 704, the UE may select the second RAT to conduct a CS call, when both the first RAT and the second RAT are available. In the preferred aspect of the present disclosure, the first RAT may comprise a RAT based on TD-SCDMA, and the second RAT may comprise a RAT based on GSM.

In one configuration, the apparatus 350 for wireless communication includes means for selecting a first RAT to conduct a PS call, when both the first RAT and a second RAT are available, and means for selecting the second RAT to conduct a CS call, when both the first RAT and the second RAT are available. In one aspect, the aforementioned means may be the processors 370 and 380 configured to perform the functions recited by the aforementioned means. In another aspect, the aforementioned means may be a module or any apparatus configured to perform the functions recited by the aforementioned means.

In summary, the present disclosure proposes a method and apparatus for allowing a hybrid TD-SCDMA/GSM mobile terminal to monitor one of these two RATs, and to be able to set up a CS or PS call in the GSM or TD-SCDMA radio network according to which radio network is available and based on a service-dependent RAT preference.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication by multi-mode user equipment (UE), comprising:
selecting a first radio access technology (RAT) to conduct a Packet-Switched (PS) call, when both the first RAT and a second RAT are available; and
selecting the second RAT to conduct a Circuit-Switched (CS) call, when both the RAT and the second RAT are available.

2. The method of claim 1, wherein the first RAT comprises a RAT based on Time Division Synchronous Code Division Multiple Access (TD-SCDMA) and the second RAT comprises a RAT based on Global System for Mobile communications (GSM).

3. The method of claim 2, further comprising:
conducting both the CS and PS calls using TD-SCDMA, if only the RAT based on TD-SCDMA is available; and
conducting both the CS and PS calls using GSM, if only the RAT based on GSM is available.

4. The method of claim 2, further comprising:
monitoring, in an idle mode, a network operating according to the RAT based on TD-SCDMA.

5. The method of claim 2, wherein:
the PS call comprises a Mobile Originated (MO) PS call; and
the MO PS call is originated using the RAT based on TD-SCDMA.

6. The method of claim 2, wherein:
the PS call comprises a Mobile Terminated (MT) PS call; and
the MT PS call is originated using the RAT based on TD-SCDMA.

7. The method of claim 2, wherein
the CS call comprises a Mobile Originated (MO) CS call, and the method further comprising
performing cell reselection before originating the MO CS call using the RAT based on GSM.

8. The method of claim 2, wherein
the CS call comprises a Mobile Terminated (MT) CS call, and the method further comprising:
originating the MT CS call in a first network operating according to the RAT based on TD-SCDMA; and
performing, during the MT CS call, a handover to a second network operating according to the RAT based on GSM.

9. The method of claim 8, wherein performing the handover comprises:
receiving, from the first network, a measurement control message and a radio bearer setup message;
in response to the measurement control message and the radio bearer setup message, transmitting, to the first network, a measurement report related to a target cell of the second network;
setting up the MT CS call in the first network after transmitting the measurement report; and
relocating the MT CS call to the target cell, wherein the relocation is initiated by the first network after the MT CS call is being set up.

10. An apparatus for wireless communication, comprising:
means for selecting a first radio access technology (RAT) to conduct a Packet-Switched (PS) call, when both the first RAT and a second RAT are available; and
means for selecting the second RAT to conduct a Circuit-Switched (CS) call, when both the RAT and the second RAT are available.

11. The apparatus of claim 10, wherein the first RAT comprises a RAT based on Time Division Synchronous Code Division Multiple Access (TD-SCDMA) and the second RAT comprises a RAT based on Global System for Mobile communications (GSM).

12. The apparatus of claim 11, further comprising:
means for conducting both the CS and PS calls using TD-SCDMA, if only the RAT based on TD-SCDMA is available; and
means for conducting both the CS and PS calls using GSM, if only the RAT based on GSM is available.

13. The apparatus of claim 11, further comprising:
means for monitoring, in an idle mode, a network operating according to the RAT based on TD-SCDMA.

14. The apparatus of claim 11, wherein:
the PS call comprises a Mobile Originated (MO) PS call; and
the MO PS call is originated using the RAT based on TD-SCDMA.

15. The apparatus of claim 11, wherein:
the PS call comprises a Mobile Terminated (MT) PS call; and
the MT PS call is originated using the RAT based on TD-SCDMA.

16. The apparatus of claim 11, wherein
the CS call comprises a Mobile Originated (MO) CS call, and the apparatus further comprising
means for performing cell reselection before originating the MO CS call using the RAT based on GSM.

17. The apparatus of claim 11, wherein
the CS call comprises a Mobile Terminated (MT) CS call, and the apparatus further comprising:
means for originating the MT CS call in a first network operating according to the RAT based on TD-SCDMA; and
means for performing, during the MT CS call, a handover to a second network operating according to the RAT based on GSM.

18. The apparatus of claim 17, wherein the means for performing the handover comprises:
means for receiving, from the first network, a measurement control message and a radio bearer setup message;
means for transmitting, to the first network in response to the measurement control message and the radio bearer setup message, a measurement report related to a target cell of the second network;
means for setting up the MT CS call in the first network after transmitting the measurement report; and
means for relocating the MT CS call to the target cell, wherein the relocation is initiated by the first network after the MT CS call is being set up.

19. A computer program product, comprising:
a computer-readable medium comprising code for:
selecting a first radio access technology (RAT) to conduct a Packet-Switched (PS) call, when both the first RAT and a second RAT are available; and
selecting the second RAT to conduct a Circuit-Switched (CS) call, when both the RAT and the second RAT are available.

20. The computer program product of claim 19, wherein the first RAT comprises a RAT based on Time Division Synchronous Code Division Multiple Access (TD-SCDMA) and the second RAT comprises a RAT based on Global System for Mobile communications (GSM).

21. The computer program product of claim 20, wherein the computer-readable medium further comprising code for:
conducting both the CS and PS calls using TD-SCDMA, if only the RAT based on TD-SCDMA is available; and
conducting both the CS and PS calls using GSM, if only the RAT based on GSM is available.

22. The computer program product of claim 20, wherein the computer-readable medium further comprising code for:
monitoring, in an idle mode, a network operating according to the RAT based on TD-SCDMA.

23. The computer program product of claim 20, wherein:
the PS call comprises a Mobile Originated (MO) PS call; and
the MO PS call is originated using the RAT based on TD-SCDMA.

24. The computer program product of claim 20, wherein:
the PS call comprises a Mobile Terminated (MT) PS call; and
the MT PS call is originated using the RAT based on TD-SCDMA.

25. The computer program product of claim 20, wherein
the CS call comprises a Mobile Originated (MO) CS call, and wherein the computer-readable medium further comprising code for
performing cell reselection before originating the MO CS call using the RAT based on GSM.

26. The computer program product of claim 20, wherein
the CS call comprises a Mobile Terminated (MT) CS call, and wherein the computer-readable medium further comprising code for:
originating the MT CS call in a first network operating according to the RAT based on TD-SCDMA; and
performing, during the MT CS call, a handover to a second network operating according to the RAT based on GSM.

27. The computer program product of claim 26, wherein said performing the handover comprises:
receiving, from the first network, a measurement control message and a radio bearer setup message;
in response to the measurement control message and the radio bearer setup message, transmitting, to the first network, a measurement report related to a target cell of the second network;
setting up the MT CS call in the first network after transmitting the measurement report; and
relocating the MT CS call to the target cell, wherein the relocation is initiated by the first network after the MT CS call is being set up.

28. An apparatus for wireless communication, comprising:
at least one processor; and
a memory coupled to the at least one processor,
wherein the at least one processor is configured to:
select a first radio access technology (RAT) to conduct a Packet-Switched (PS) call, when both the first RAT and a second RAT are available; and
select the second RAT to conduct a Circuit-Switched (CS) call, when both the RAT and the second RAT are available.

29. The apparatus of claim 28, wherein the first RAT comprises a RAT based on Time Division Synchronous Code Division Multiple Access (TD-SCDMA) and the second RAT comprises a RAT based on Global System for Mobile communications (GSM).

30. The apparatus of claim 29, wherein the at least one processor is also configured to:
conduct both the CS and PS calls using TD-SCDMA, if only the RAT based on TD-SCDMA is available; and
conduct both the CS and PS calls using GSM, if only the RAT based on GSM is available.

31. The apparatus of claim 29, wherein the at least one processor is also configured to
monitor, in an idle mode, a network operating according to the RAT based on TD-SCDMA.

32. The apparatus of claim 29, wherein:
the PS call comprises a Mobile Originated (MO) PS call; and
the MO PS call is originated using the RAT based on TD-SCDMA.

33. The apparatus of claim 29, wherein:
the PS call comprises a Mobile Terminated (MT) PS call; and
the MT PS call is originated using the RAT based on TD-SCDMA.

34. The apparatus of claim 29, wherein
the CS call comprises a Mobile Originated (MO) CS call, and wherein the at least one processor is also configured to
perform cell reselection before originating the MO CS call using the RAT based on GSM.

35. The apparatus of claim 29, wherein
the CS call comprises a Mobile Terminated (MT) CS call, and wherein the at least one processor is also configured to:
originate the MT CS call in a first network operating according to the RAT based on TD-SCDMA; and
perform, during the MT CS call, a handover to a second network operating according to the RAT based on GSM.

36. The apparatus of claim 35, wherein the at least one processor is also configured to:
receive, from the first network, a measurement control message and a radio bearer setup message;
transmit, to the first network in response to the measurement control message and the radio bearer setup message, a measurement report related to a target cell of the second network;
set up the MT CS call in the first network after transmitting the measurement report; and
relocate the MT CS call to the target cell, wherein the relocation is initiated by the first network after the MT CS call is being set up.
